(19) United States
(12) Patent Application Publication
(10) Pub. No.: US 2010/0007672 A1
(43) Pub. Date: Jan. 14, 2010

(54) RASTER AND RASTERISATION METHOD IN GRAPHIC PROCESSING

(76) Inventors: Xiang Li, Ji Lin City (CN); Yan Zhou, Shanghai (CN); Rongquan You, Shanghai (CN); Franklin C. Crow, Portola Valley, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/368,901

(22) Filed: Feb. 10, 2009

(30) Foreign Application Priority Data
Jul. 10, 2008 (CN) 200810126867.6

(51) Int. Cl. G06T 1/60

(52) U.S. Cl. 345/530

(57) ABSTRACT

The present invention provides a raster module. The rater module comprises a coarse raster for rasterizing input data; and a fine raster receiving data from the coarse raster, wherein the fine raster comprises a buffer for buffering data from the coarse raster. The present invention provides a small raster unit while maintaining the performance without lost in other functions, and therefore achieves cost reduction in chip manufacturing.

### CROSS-REFERENCE TO RELATED APPLICATIONS

This application claims benefit of Chinese (PRC) patent application number 200810126867.6, filed Jul. 10, 2008, which is herein incorporated by reference.

### FIELD OF INVENTION

The present invention relates to graphic processing; more specifically, the invention relates to raster graphics.

### BACKGROUND

With the present technology development progressing, a raster normally comprises a plurality of units in order to meet the performance required. Each one of the units in the raster occupies a certain area on the chip. As the chip size decreasing, reducing size of the area that the raster occupies on the chip becomes desirable.

Currently, the reduction of the raster size is achieved by replacing the conventional four-units raster (four 8×8) with one-unit raster (one 8×8). Further, the throughput of the raster is decreased from 256 pixels per clock (ppc) to 64 ppc. Please refer to FIG. 1, which describes raster scan processes in 64 ppc and 256 ppc. It can be understood that two squares in one row are scanned when the throughput is 64 ppc, and the two squares in the next row are scanned subsequently. In the situation of 256 ppc throughput, four squares in one row are scanned and then the four squares in the next row are scanned. Therefore, the obvious difference between the two raster scan processes is that the 64 ppc scans 8×4 pixels at a time, while the 256 ppc scans 16×4 pixels at a time.

Accompanied with the consequence in raster size reduction, i.e. throughput change, some functions of the raster are lost. For example, a fast-clear function is lost because it is only activated in the 16×4 processing. Other performances, such as transformations, are also affected as the processing size is changed.

Therefore, it is required to have a raster that is small and also achieves the desired processing performance requirement.

### SUMMARY OF INVENTION

To solve the above problems, an embodiment of the present invention provides a raster module. The rater module comprises a coarse raster for rasterizing input data; and a fine raster receiving data from the coarse raster, wherein the fine raster comprises a buffer for buffering data from the coarse raster.

Another embodiment of the present invention provides a graphic processing unit, comprising a raster module comprising a coarse raster for rasterizing input data; and a fine raster receiving data from the coarse raster unit, comprising a buffer for buffering data from the coarse raster.

Yet another embodiment of the present invention provides a method of rasterization, comprising coarse rastering an input data to form a rasterised data; adding a flag into the rasterised data; and transferring the rasterised data with the flag to a fine raster; determining whether to buffer the rasterised data according to the flag.

### BRIEF DESCRIPTION OF THE DRAWINGS

FIG. 1 describes raster scan processes in 64 pixels per clock and 256 pixels per clock.

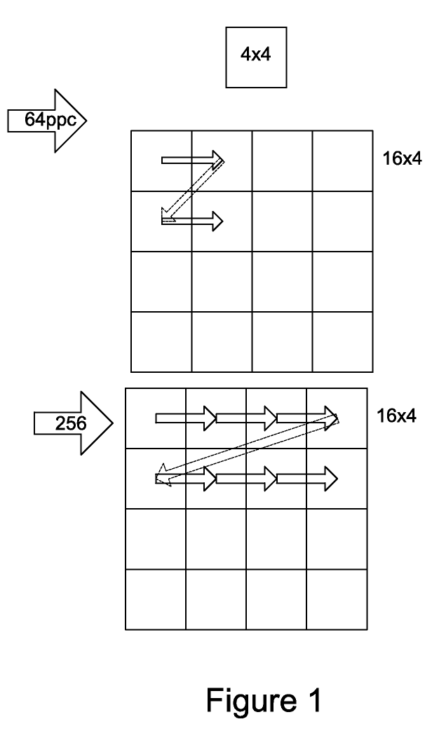

FIG. 2 represents a block diagram of a raster module according to an embodiment of the present invention.

FIG. 3 illustrates the flow chart of raster process according to an embodiment of the present invention.

### DETAILED DESCRIPTION OF THE INVENTION

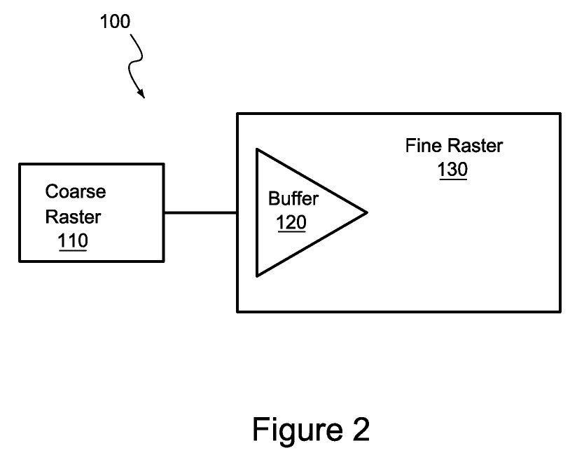

FIG. 2 represents a block diagram of a raster module 100 according to an embodiment of the present invention. Raster module 100 comprises a coarse raster 110 and a fine raster 130; wherein fine raster 130 comprises a buffer 120. Coarse raster 110 receives input data for rasterisation and output data to fine raster 130 after coarse rasterisation. Coarse raster 110 adds a flag to the data to be output to the fine raster 130. Fine raster 130 receives data from coarse raster 110 for rastering data in finer resolution. Buffer 120 in fine raster 130 is specifically used for buffering data received from coarse raster 110.

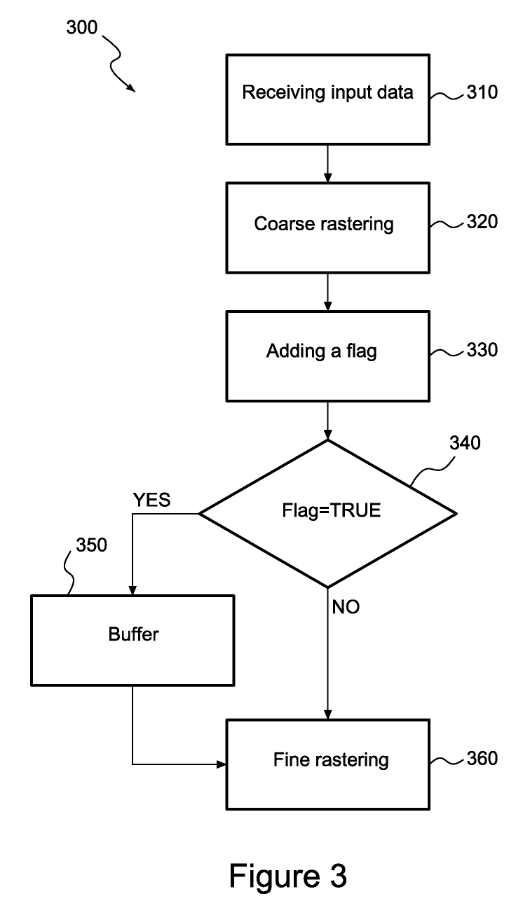

The process flow diagram of raster is illustrated in FIG. 3., which illustrates the flow chart 300 of a raster process according to an embodiment of the present invention. In step 310, input data is received by a coarse raster. The input data is coarse rasterised by the coarse raster as shown in step 320, and then in step 330 a flag is added into the rasterised data. Subsequently, the rasterised data is transferred from the coarse raster to a fine raster. After receiving the rasterised data, the fine raster determines whether to buffer the rasterised data or not according to the flag. In the above process, the flag is set as “TRUE” by the coarse raster when an n×n (e.g., 8×8) pixel block is received. As a result, the fine raster reads the flag, which is “TRUE”, and the n×n pixel block is stored in a buffer. When the next n×n pixel block is received from the coarse raster, the two n×n pixel blocks merge together in the buffer to form a 2n×n (e.g., 16×8) pixel block. The fine raster then rasterises the 2n×n pixel block, thus the rasterisation of the fine raster can be performed n×½n at a time. Therefore, the embodiment of the present invention provides a raster module with reduced size without compensating performance or losing functions.

Although the embodiments disclosed above are discussed in the scope of providing solutions in response to a need for raster data, one of ordinary skill in the art can easily adopt the same raster module or method for the providing of other type of purposes. Variations, modifications, and other implementations of what is described herein will occur to those of ordinary skill in the art without departing from the spirit and scope of the present invention as claimed. Accordingly, the present invention is to be defined not by the preceding illustrative description but instead by the spirit and scope of the following claims.

1. A rater module, comprising:
a coarse raster for rasterizing input data; and
a fine raster receiving data from the coarse raster, comprising:
a buffer for buffering data from the coarse raster.

2. The rater module according to claim 1, wherein the coarse raster adds a flag to rasterised data.

3. The rater module according to claim 2, wherein the fine raster unit determining whether to buffer the data in the buffer received according to the flag.

4. The rater module according to claim 1, wherein data from the coarse raster comprises at least an n×n data.

5. The rater module according to claim 1, wherein the buffering data comprising buffering the data to merge two n×n to 2n×n.

6. The rater module according to claim 5, wherein the n is 4.

7. A graphical processing unit, comprising:
a raster module, comprising:
a coarse raster for rasterizing input data; and
a fine raster receiving data from the coarse raster unit, comprising:
a buffer for buffering data from the coarse raster.

8. The graphical processing unit according to claim 7, wherein the coarse raster unit adds a flag to rasterised data.

9. The graphical processing unit according to claim 8, wherein the fine raster unit determining whether to buffer the data received according to a flag.

10. The rater module according to claim 7, wherein data from the coarse raster comprises at least an n×n data.

11. The graphical processing unit according to claim 7, wherein the buffering data comprising buffering the data to merge two n×n to 2n×n.

12. The graphical processing unit according to claim 11, wherein the n is 4.

13. A method of rasterization, comprising:
coarse-rastering an input data to form a rasterised data;
adding a flag into the rasterised data;
transferring the rasterised data with the flag to a fine raster; and
determining whether to buffer the rasterised data according to the flag.

14. The method according to claim 13, wherein the fine raster comprises a buffer for buffering the rasterised data.

15. The method according to claim 13, the flag is set to be “TRUE” when partial data block is transferred.

16. The method according to claim 13, wherein buffering is performed when the flag is “TRUE.”

17. The method according to claim 13, further comprising:
merging buffered data; and
fine-rasterizing merged data.

18. The method according to claim 17, wherein the buffered data comprises at least an n×n data.

19. The method according to claim 17, wherein merging the buffered data comprising merging two n×n to 2n×n.

20. The method according to claim 19, wherein n is 4.
